(19) United States
(12) Patent Application Publication
(10) Pub. No.: US 2006/0061947 A1
(43) Pub. Date: Mar. 23, 2006

(54) Frame and liquid crystal display device using the same

(75) Inventors: Hsueh Tien Chang, Miao-Li (TW); Ching-Tung Hsieh, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/229,908

(22) Filed: Sep. 19, 2005

(30) Foreign Application Priority Data
Sep. 17, 2004 (TW) 93214876

(51) Int. Cl. G06F 1/16

(52) U.S. Cl. 361/681

(57) ABSTRACT

A liquid crystal display module (60) includes a liquid crystal panel (30) and a frame (20) for holding the liquid crystal panel. The frame includes a base portion (25), four sidewalls (21, 22, 23, 24) provided on the base portion. The four sidewalls and the base portion cooperatively define a receiving space. One of the four sidewalls includes an elastic clasp (231) thereat, for elastically retaining the liquid crystal panel in the receiving space. With the configuration, a reducing cost, thickness and weightiness are obtained and the liquid crystal display module may be easily and conveniently assembled or disassembled.

### FIELD OF THE INVENTION

The present invention relates to a frame for holding a liquid crystal panel, and a liquid crystal display device using the frame.

### BACKGROUND

Because a liquid crystal display device (LCD) has the merits of being thin, light in weight, and drivable by a low voltage, it is extensively employed in various electronic devices.

Referring to FIG. 9, a typical liquid crystal display module 10 includes a liquid crystal panel 100, a backlight module 101, a bottom frame 122, and a top frame 124. The bottom frame 122 is generally made of metal, and has a plurality of protrusions 136. The top frame 124 is generally made of plastic, and has a plurality of holes 138.

The liquid crystal panel 100 is disposed on the backlight module 101. The liquid crystal panel 100 and the backlight module 101 are accommodated in the bottom frame 122. The protrusions 136 of the bottom frame 122 mate in the holes 138 of the top frame 124, whereby the liquid crystal panel 100 and the backlight module 101 are held in the bottom frame 122.

Both the top frame 124 and the bottom frame 122 are necessary for holding the liquid crystal panel 100 and the backlight module 101 in place. This increases a thickness and weight of the liquid crystal display module 10, and adds to costs.

To overcome the problems described above, an adhesive tape is employed for combining a liquid crystal panel and a bottom frame. In such case, no top frame is needed, and cost of the liquid crystal display module is reduced.

The adhesive tape is usually adhesive on both sides thereof. One side of the adhesive tape is attached on the liquid crystal panel, and the other side of the adhesive tape is attached on the bottom frame. On occasions, the liquid crystal display module may need to be disassembled, for example when the frame or the liquid crystal panel needs to be replaced. In disassembly, the adhesive tape has to be torn out and damaged. In this process, some surplus adhesive tape may be left on the liquid crystal panel and contaminate the liquid crystal panel.

Therefore, a new frame and a liquid crystal display device employing the frame are desired, in order to overcome the above-described problems.

### SUMMARY

In one embodiment, a frame for holing a liquid crystal panel includes a base portion and four sidewalls provided on the base portion. The four sidewalls and the base portion cooperatively define a receiving space. One of the four sidewalls includes an elastic clasp thereat, for elastically retaining the liquid crystal panel in the receiving space.

In another embodiment, a liquid crystal display module includes a liquid crystal panel and a frame for holding the liquid crystal panel. The frame includes a base portion, four sidewalls provided on the base portion. The four sidewalls and the base portion cooperatively define a receiving space. One of the four sidewalls includes an elastic clasp thereat, for elastically retaining the liquid crystal panel in the receiving space.

The frame and the liquid crystal display module provided herein have the following advantages. The clasp is employed to fix the liquid crystal panel in the frame, no typical top frame is needed, and a reducing cost, thickness and weightiness are obtained. On the other hand, the liquid crystal panel may be directly fixed in or taken out of the frame by applying a force onto the clasp, which make the liquid crystal display module be easily and conveniently assembled or disassembled.

Other advantages, and novel features will become more apparent from the following detailed description when taken in conjunction with the accompanying drawings.

### BRIEF DESCRIPTION OF THE DRAWINGS

FIG. 1 is an isometric view of a frame according to a first embodiment of the present invention.

FIG. 2 is an enlarged view of a circled portion II of FIG. 1.

FIG. 3 is an enlarged view of a circled portion III of FIG. 1.

FIG. 4 is an exploded, isometric view of a liquid crystal display module according to a second embodiment of the present invention.

FIG. 5 is an assembled view of the liquid crystal display module of FIG. 4.

FIG. 6 is a cross-sectional view taken along line VI-VI of FIG. 5.

FIG. 7 is a cross-sectional view taken along line VII-VII of FIG. 5.

FIG. 8 is similar to FIG. 7, but in respect of a liquid crystal display module according to a third embodiment of the present invention.

FIG. 9 is a cross-sectional view of part of a conventional liquid crystal display module.

### DETAILED DESCRIPTION OF PREFERRED EMBODIMENTS

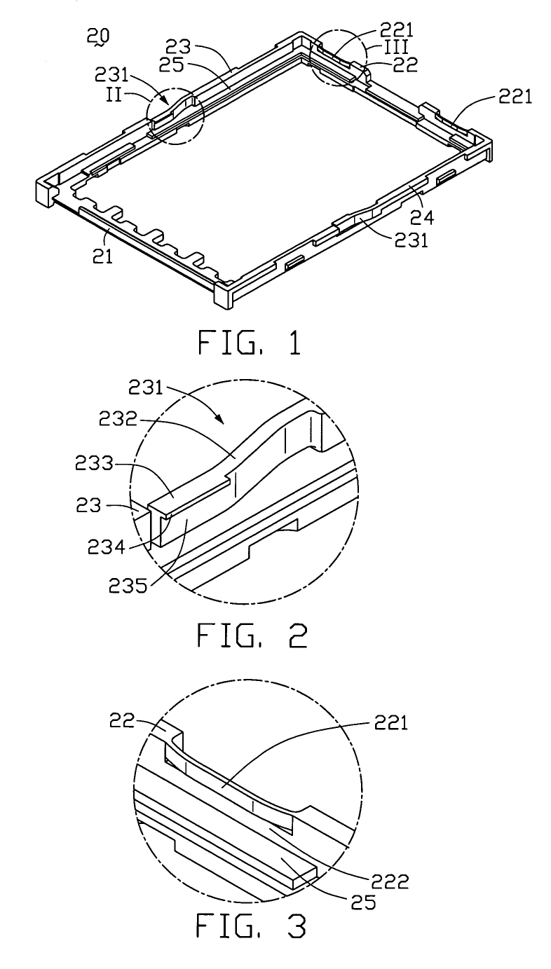

Referring to FIG. 1, a frame 20 according to the first embodiment of the present invention includes a rectangular base portion 25, a first sidewall 21, a second sidewall 22 opposite to the first sidewall 21, a third sidewall 23, and a fourth sidewall 24 opposite to the third sidewall 23. The base portion 25 itself is frame-like, comprising four beam portions surrounding a large central opening. The four sidewalls 21, 22, 23, 24 extend from the base portion 25. The sidewalls 21, 22, 23, 24 define a receiving space for accommodating a backlight module and a liquid crystal panel.

Each of the third sidewall 23 and the fourth sidewall 24 includes a clasp 231 thereon. The two clasps 231 are arranged symmetrically opposite each other.

Referring to FIG. 2, each clasp 231 includes an elastic arm 232, and a clasp end 233 disposed at a free end of the elastic arm 232. The clasp end 233 protrudes slightly into the receiving space. The clasp end 233 can be pushed to move outwardly in a direction substantially perpendicular to the third sidewall 23, with the elastic arm 232 bending accordingly. The clasp end 233 includes a body 235, and a first protrusion 234 extending perpendicularly inwardly from the body 235. The first protrusions 234 of the clasps 231 cooperate with the base portion 25 for preventing movement of the liquid crystal panel and the backlight module in vertical directions. Also, the bodies 235 of the clasps 231 are used for preventing the liquid crystal panel and the backlight module from moving in horizontal directions.

Referring to FIG. 3, the second sidewall 22 has two arc parts 221, each projecting slightly into the receiving space. There is a gap 222 defined between each arc part 221 and the base portion 25, for ensuring that the arc part 221 can elastically deform substantially in an outward direction under applied external force.

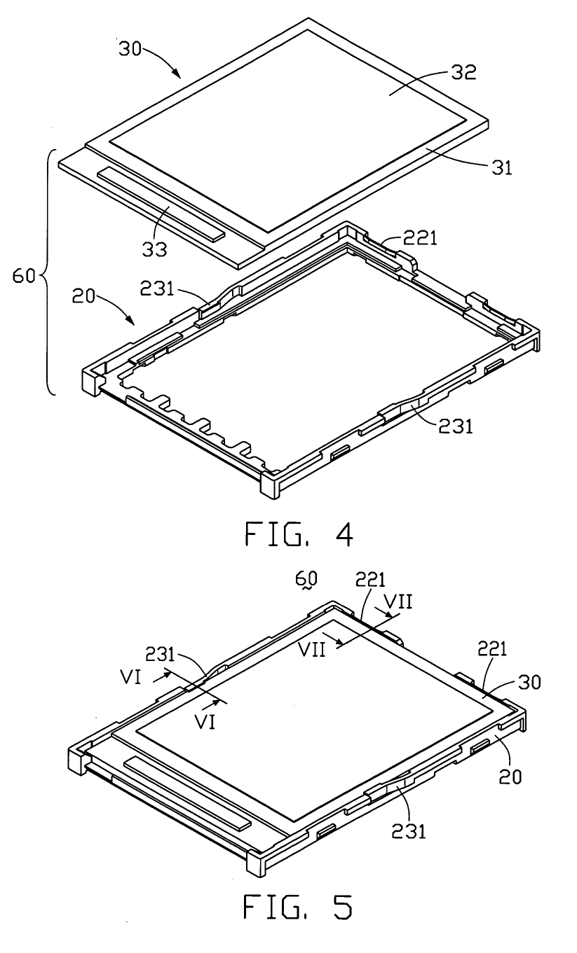

Referring to FIG. 4, a liquid crystal display module 60 according to the second embodiment of the present invention includes a liquid crystal panel 30 and the frame 20. The liquid crystal panel 30 generally includes a glass substrate 31, and a polarizer 32 and a driver integrated circuit (driver IC) 33 disposed on the glass substrate 31.

A process of assembling the liquid crystal panel 30 and the frame 20 together comprises the following steps: applying a force to the clasp 231 of the sidewall 23 to make the clasp 231 of the sidewall 23 bend outwardly; putting the liquid crystal panel 30 on the base portion 25, and pushing one side of the liquid crystal panel 30 against the clasp 231 of the sidewall 24, and positioning another side of the liquid crystal panel 30 so that it abuts against one of the two arc parts 221; pressing down the liquid crystal panel 30 so that it is received in the receiving space; and removing the pressing force, whereby the two clasps 231 resiliently rebound inwardly. Thus, the clasps 231 the two arc parts 221 of the frame 20, and the first sidewall 21 cooperate to hold the liquid crystal panel 30 in the frame 20.

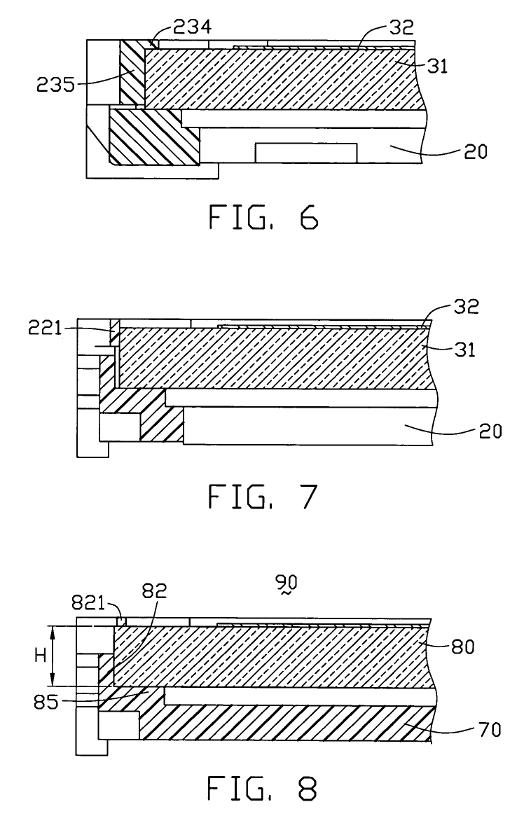

An assembly of the liquid crystal panel 30 and the frame 20 is shown in FIGS. 5, 6 and 7. The liquid crystal panel 30 is accommodated in the frame 20. The clasps 231 of the frame 20 hold two opposite sides of the liquid crystal panel 30, whereby the clasps 231 provide horizontal elastic forces to prevent the liquid crystal panel 30 from moving in horizontal directions. In addition, the first protrusions 234 of the clasps 231 cooperate with the base portion 25 to prevent movement of the liquid crystal panel 30 in vertical directions. Furthermore, the arc parts 221 prevent the liquid crystal panel 25 from moving in horizontal directions.

When the liquid crystal panel 30 is taken out of the frame 20, a force is applied to either or both of the clasps 231, so that either or both of the clasps 231 bend outwardly. Then the liquid crystal panel 30 can be readily removed from the frame 20 without being damaged.

The liquid crystal display module 60 has the following advantages. Because the two clasps 231 are employed to fix the liquid crystal panel 30 in the frame 20, no top frame portion is needed. This reduces the cost, thickness and weight of the liquid crystal display module 60. Further, the liquid crystal panel 30 may be directly fixed in or taken out of the frame 20 by applying a force to either or both of the clasps 231. This makes assembly and disassembly of the liquid crystal display module 60 easy and convenient.

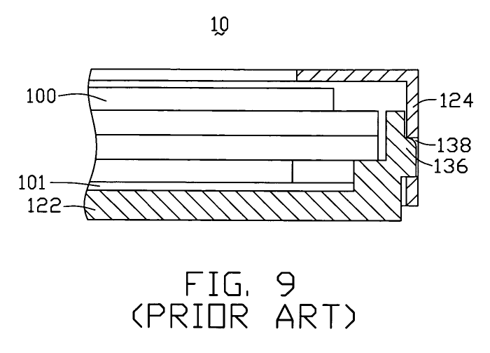

A liquid crystal display module 90 according to the third embodiment of the present invention is shown in FIG. 8. The liquid crystal display module 90 includes a liquid crystal panel 80 and a frame 70. The frame 70 includes a rectangular, generally flat base portion 85, and a second sidewall 82 having a second protrusion 821 extending inwardly therefrom. The second protrusion 821 is located immediately above a receiving space of the frame 70, and may be rigid. There is a gap between the second protrusion 821 and the base portion 85, and a height H of the gap is larger than a thickness of the liquid crystal panel 80. Thus one side of the liquid crystal panel 80 may be received in the gap. Then the second protrusion 821 helps prevent movement of the liquid crystal panel 80 in vertical directions.

The frame according to any of the above-described embodiments may be configured for use with liquid crystal display modules having different sizes. In alternative embodiments, the frame may include only one clasp and one arc part cooperating with the clasp. Such embodiments are advantageous when the frame is configured for use with a liquid crystal display module having a relatively small size.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

We claim:

1. A frame for holding a liquid crystal panel, comprising:
a base portion; and
four sidewalls provided at the base portion, the sidewalls and the base portion cooperatively defining a receiving space;
wherein one of the four sidewalls comprises an elastic first clasp thereat, for elastically retaining the liquid crystal panel in the receiving space.

2. The frame according to claim 1, wherein the base portion comprises a plurality of beam portions surrounding a central opening.

3. The frame according to claim 1, wherein the base portion is rectangular and generally flat.

4. The frame according to claim 1, wherein the first clasp comprises an elastic arm and a clasp end.

5. The frame according to claim 1, further comprising a protrusion provided at another one of the sidewalls that connects with the sidewall having the first clasp.

6. The frame according to claim 5, wherein the protrusion projects inwardly.

7. The frame according to claim 5, wherein the protrusion is elastic.

8. The frame according to claim 1, further comprising a second clasp provided at another one of the sidewalls that is opposite to the sidewall having the first clasp.

9. A liquid crystal display module comprising a frame and a liquid crystal panel, the frame comprising:
a base portion;
four sidewalls provided at the base portion, the sidewalls and the base portion cooperatively defining a receiving space;
wherein one of the four sidewalls comprises an elastic first clasp thereat, for elastically retaining the liquid crystal panel in the receiving space.

10. The liquid crystal display module according to claim 9, wherein the base portion is comprises a plurality of beam portions surrounding a central opening.

11. The liquid crystal display module according to claim 9, wherein the base portion is rectangular and generally flat, and the base portion is utilized to support the liquid crystal panel.

12. The liquid crystal display module according to claim 9, wherein the first clasp comprises an elastic arm and a clasp end, and the clasp is utilized to fix the liquid crystal panel.

13. The liquid crystal display module according to claim 9, further comprising a protrusion provided at another one of the sidewalls that connect having the first clasp.

14. The liquid crystal display module according to claim 13, wherein the protrusion projects inwardly.

15. The liquid crystal display module according to claim 13, wherein the protrusion is elastic and presses against the liquid crystal panel.

16. The liquid crystal display module according to claim 13, wherein there is a gap between the protrusion and the base portion, and a width of the gap is not more than a thickness of the liquid crystal panel.

17. The liquid crystal display module according to claim 9, further comprising a second clasp provided at another one of the sidewalls opposite to the sidewall having the first clasp.

18. A liquid crystal display module comprising:
a base portion;
at least three sidewalls located on a periphery of the base portion, the sidewalls and the base portion cooperatively defining a receiving space; and
a liquid crystal panel located in said receiving space; wherein
the sidewalls comprise means for generating a lateral force to hold said liquid crystal panel in position, and means for blocking upward movement of the liquid crystal panel.

19. The module as claimed in claim 18, wherein said means for generating the lateral force is discrete from said means for blocking upward movement of the liquid crystal panel.
